(19) United States
(12) Patent Application Publication
(10) Pub. No.: US 2007/0161378 A1
(43) Pub. Date: Jul. 12, 2007

(54) Method of evaluating the number of individuals present in a geographical area

(76) Inventors: Francois Marchand, Le Pradet (FR); Alain Giaccone, Chabottes (FR)

Correspondence Address: CLARK & BRODY, 1090 VERMONT AVENUE, NW, SUITE 250, WASHINGTON, DC, 20005, US

(21) Appl. No.: 10/597,770

(22) PCT Filed: Feb. 4, 2005
(86) PCT No.: PCT/FR05/00250

§ 371 Date: Aug. 7, 2006

(30) Foreign Application Priority Data
Feb. 9, 2004 (FR) 0401233

(51) Int. Cl. H04Q 7/20

(52) U.S. Cl. 455/456.1

(57) ABSTRACT

The measurement method makes use of the mobile telephones of individuals as an indicator of their presence in a geographical area. The method makes it possible to distinguish between variation in the population usually present in a geographical area and variation in the population additional thereto.

In general, the present invention relates to a method of measuring variation in the number of individuals present in a predetermined geographical area over a period of time referred to as an “analysis period”.

More precisely, the invention makes it possible to distinguish within the total variation in the number of individuals, between variation in the population that is usually present in said geographical area and variation in the population that is additional thereto.

### BACKGROUND OF THE INVENTION

Knowledge of the variation in the additional population can be used in numerous applications, in particular when managing road traffic, since it makes it possible to forecast population flows into and out from the geographical area.

The method also possesses a particular application in the field of hazard management, since it makes it possible, for example when making provision for a natural disaster, to put measures into place that differ appropriately for local populations and for visitor populations.

In another field, the invention can also be used in particular for dimensioning a telecommunications network installed in such a region, with it being possible to modify the resources particular to said network (by adding resources or removing them) over time in order to provide a quality of service that is optimized as a function of variation in the population in the area.

Various methods are known for estimating a population in a predetermined geographical area.

The document entitled “Méthode des flux” [Method of flows]: No. 56 of the journal “Analyses et Perspectives du Tourisme” published by the Observatoire National du Tourisme (ONT) describes in particular a method of measuring variation in the population present on a site on the basis of traffic flows in various transport means.

Unfortunately, that method presents a main drawback in that it can be applied only to sites devoted very largely to tourism, since estimating the people resident on site cannot be performed in satisfactory manner.

One of the principles of the invention consists in using the mobile telephones of individuals as an indicator of presence in a geographical area.

This presence indicator is particularly advantageous, in particular in developed countries, since the fraction of the population carrying such equipment (and in particular a cell phone) is very large, and furthermore is still increasing. The invention can thus be applied in practice to any geographical area.

Document FR 2 827 689 describes a method of providing information that makes use of such a presence indicator in order to extract from a database of a mobile telephone operator pre-established profiles of volunteers (people registered on a dedicated site) present in a geographical area in order to adapt that area to the interests of people having such profiles.

However that method does not make it possible to determine the number of individuals present in the geographical area, nor, a fortiori, does it enable variation in said number over time to be measured.

Patent document US 2002/0111172 describes a method of determining the profile of a person by tracking over time the places where that person uses a mobile telephone, and by analyzing the characteristics of those places.

That is a method of analyzing the movements of one subscriber, in order to predict that person's behavior. That method does not make it possible to determine variation in the population of a geographical area. Furthermore, it relies on analyzing the movements of individuals, and according to the legislation or practice in certain areas, that can be considered as being contrary to requirements to respect personal freedoms.

### OBJECTS AND SUMMARY OF THE INVENTION

The invention makes it possible to mitigate the above-mentioned drawbacks. To this end, the invention provides a method of measuring the variation of the total number of individuals present in a determined geographical area over an analysis period, including distinguishing between variation in the population that is usually present in said area and the variation in the population additional thereto, each individual being in a position to use mobile equipment that is capable of being located, the method comprising:

at least one calibration stage comprising the following steps:
generating a first request to obtain from a database the identifiers of mobile equipments that are active at least once in said geographical area during a calibration period; and
determining for each identifier, an area flag representative of the fact that a habitual place of use of the equipment associated with the identifier is or is not situated in said predetermined area; and

at least one measurement stage comprising the following steps:
generating a second request for obtaining, from said database, first temporal data constituted by the total number of active equipments in the area, at various measurement instants in the analysis period;
generating a third request to obtain, from said database, for the identifiers associated with an area flag representative of having a habitual place of use situated in said area, second temporal data constituted by the number of said identifiers that are associated with an equipment that is active in said area at said measurement instants; and
measuring the variation in the total number of individuals present in said predetermined geographical area, during said analysis period, while distinguishing between variation in the population usually present in said area and variation in the additional population, on the basis of said first and second temporal data.

Thus, the calibration stages serves to determine statistically the population usually present in a given geographical area. The person skilled in the art will understand that this calibration stage is preferably selected to take place over a period when the local population is likely to vary little. Naturally, the longer the calibration stage, the greater the precision of the estimate of the local population.

By detecting the presence or the absence within the area of individuals normally present in said area at various instants in the analysis period, the measurement stage makes it possible to construct a histogram of people who are present and absent.

In certain areas, this information is of particularly great importance, for example it enables specific measures to be implemented in a hazard-management application in a way that cannot be achieved when measuring only variation in the total population within the area. This applies in particular in a city that continuously receives a volume of visitors that is large and substantially constant.

Preferably, said third request is generated solely for a sample of the set of identifiers associated with an area flag representative of having a habitual place of use situated in said area. This makes it possible to limit the complexity of the measurement stage.

Preferably, during said determining step, an identifier is associated with an area flag representative of the fact that a habitual place of use associated with said identifier is situated in said area, when a utilization rate of said equipment over said calibration period is greater than a predetermined threshold.

This characteristic makes it possible advantageously to avoid including individuals who are present in the area only occasionally as forming part of the population that is usually present in the area.

Preferably, during said measuring step, account is taken of the percentage of individuals that dispose of mobile equipments. This characteristic makes it possible to relate the measurement results to the total population.

The measurement method can be used for dimensioning a telecommunications network that is installed or that is to be installed in the predetermined area.

It can also be used for analyzing or anticipating flows of population movement entering or leaving the area.

It can also be used for triggering specific measures for protecting resident or visiting populations in a hazardous geographical area, for example when making provision for a natural disaster.

The present invention is also particularly applicable to the tourism industry. In this industry, it is the practice to make use of the following terms:

“visitor”: any person going for a period of not more than twelve months to a location situated in that person's country of residence or in another country, but that does not correspond to that person's usual environment. Visitors form part of the “additional” population in the meaning of the invention;

“tourist”: a visitor who passes at least one night in a visited location, where the “bed night” is a unit used for measuring physical flows of occupancy in tourism; and

“excursionist”: a visitor who is not a tourist.

For further information on these various concepts the person skilled in the art should refer to the document “Dictionnaire des concepts et méthodes de l'observation touristique” [Dictionary of concepts and methods in observing tourism], published by Observatoire National du Tourisme in France under the No. ISBN 2-11-091622-2.

The invention also relates to using the measurement method described briefly above for using the first and second temporal data to measure variation in the number of tourists and in the number of excursionists in the area over the analysis period.

### BRIEF DESCRIPTION OF THE DRAWINGS

Other aspects and advantages of the present invention appear more clearly on reading the following description of particular implementations, this description being given purely by way of non-limiting example and being made with reference to the accompanying drawings, in which:

FIG. 1 shows a mobile telecommunications network and a database suitable for use by a computer implementing a measurement method in accordance with the invention, in a preferred implementation;

FIG. 2 is a flow chart showing the main steps in a measurement method in accordance with the invention, in a preferred implementation;

FIGS. 3 to 5 represent intermediate data structures used in the measurement method of FIG. 2; and

FIG. 6 is a presence histogram together with curves showing variations in populations as obtained using the measurement method of FIG. 2.

### MORE DETAILED DESCRIPTION

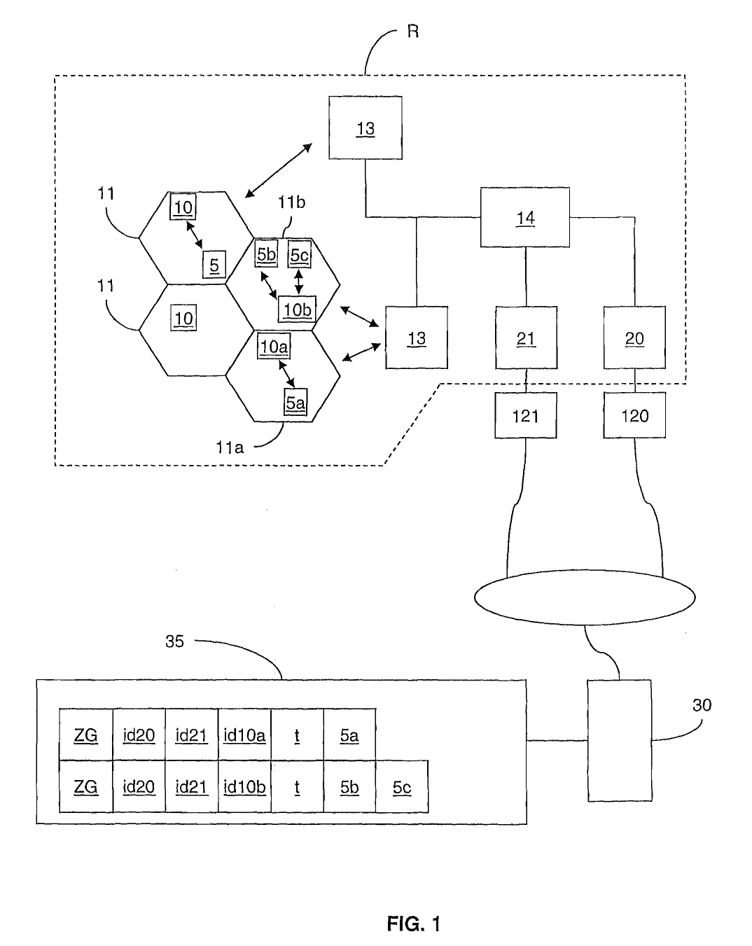

FIG. 1 shows in particular a mobile telecommunications network R of the kind known to the person skilled in the art. In the example described herein, it is a GSM network, but the invention can be used with any type of network enabling a user of mobile equipment to be located.

In known manner, the network comprises cells 11 having base stations 10 connected via controllers 13 to switching centers 14.

For more details concerning the architecture of a GSM network, reference can be made to the document entitled “Rapport du Gouvernement au Parlement—Juillet 2001 Structure d'un réseau GSM” [Government report to Parliament—July 2001, Structure of a GSM network] published on the Internet at the following address: http://www.telecom.gouv.fr/documents/rap_mobile/annexe9.html.

In known manner, when a user switches on mobile equipment or when a user penetrates into a cell 11, the mobile equipment 5 attempts to make a connection with the base station 10 of the cell 11 by scanning the band of frequencies that are available in said cell 11.

For each mobile station 5 connected to a base station 10 of the cell 11, a number for the cell 11 is stored in a register 20 known as the “visitor location register” (VLR).

The visitor location register 20 is connected to the switching center 14 that manages the cell 11.

Thus, the switching center 14 is continuously aware of the identifiers of the mobile terminals 5 present in a cell 11 to which it is connected.

In addition, a second register 21 known as the “home location register” (HLR) is connected to the switching center 14. The home location register 21 manages the subscribers of the mobile telecommunications network operator. In particular, it stores the following information:

the identifier of a subscriber's mobile equipment 5;

the call number of that subscriber;

a subscriber profile; and

the address of the visitor location register 20 that corresponds to the switching center 14 of the cell 11 most recently visited by the mobile equipment 5.

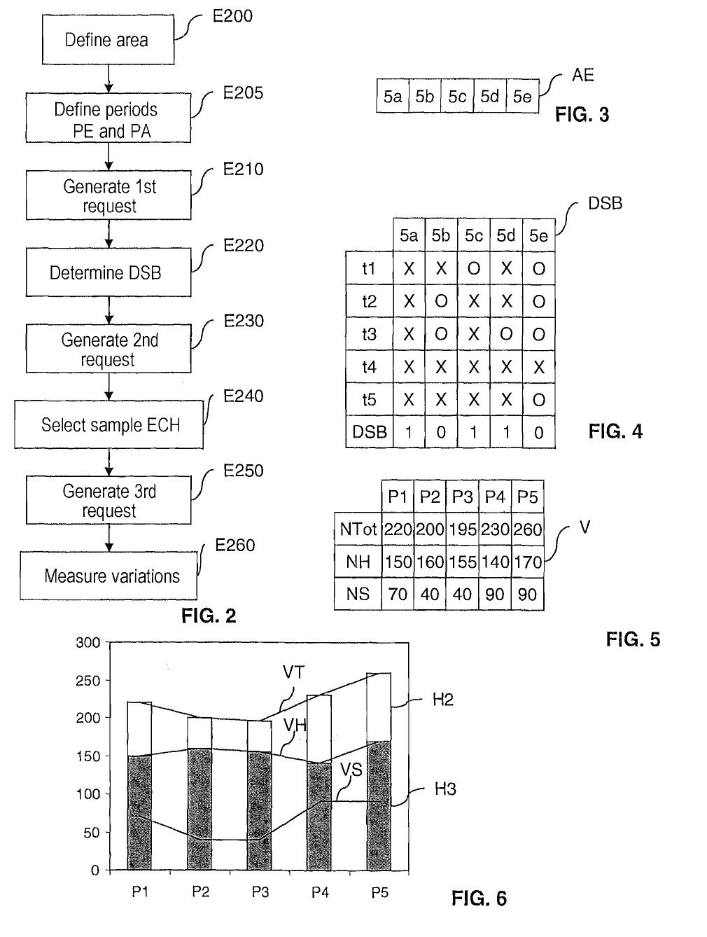

FIG. 2 shows the main steps of a measurement method in accordance with the invention in a preferred implementation.

In the example described herein, the measurement method is implemented by a computer program executed by a computer referenced 30 in FIG. 1.

The measurement method comprises a first step E200 of defining the geographical area in which it is desired to measure variation in the total number of individuals over a predetermined period of time referred to as the “analysis period”.

This defining step E200 consists in defining a portion of territory, where the size of the territory can be arbitrary (a county, a ski or seaside resort, a district, a beach, . . . ) and in determining which cells 11 cover the territory. In the example described herein, it is assumed that the geographical area under study is covered by cells 11a and 11b of FIG. 1.

In a preferred implementation, the geographical definition of the territory is determined in association with the future users of the results, by summarizing the situation and the boundaries of the territory concerned using a geographical information system (GIS) or any other conventional mapping device.

Preferably, the boundaries of the territory in question are summarized using latitude and longitude coordinates, or in another implementation using Lambert's coordinates.

Thus, the computer program stores in a database 35 connected to the computer 30:

the parameters ZG defining the territory (Lambert's or other coordinates);

the addresses id20 (or id21) of the visitor location registers (or of the home location registers) of the cells 11a and 11b of the geographical area; and

the addressees 10a, 10b of the base stations present in the geographical area.

In practice, these various addresses are obtained from the operator of the network R.

In the preferred implementation described herein, the computer 30 establishes a data flow with the visitor location register 20 and/or the home location register 21 of the operator in order to transfer into the database 35 the identifiers 5a, 5b, 5c of the mobile equipments that are active in the geographical area at a given instant or during a time period P.

The data flow is preferably encrypted and compressed prior to transmission. It is not set up directly with the register 20 or 21, but with a computer 120/121 located physically beside the register and connected thereto over a broadband connection of the gigabit Ethernet type.

Thus, the database 35 shown in FIG. 1 stores the fact that at instant t, only terminals 5a, 5b, and 5c were active in the area under study, the terminal 5a being connected to the base station 10a with the terminals 5b and 5b being connected to the base station 5b.

The method of the invention comprises mainly:

one (or more) so-called “calibration” stages for determining those individuals that posses mobile equipment (cell phone or any other equipment that can be located by the network R), having a habitual place of use situated in the area under study; and

one (or more) “measurement” stages during which variation in the total number of individuals present in the predetermined geographical area is measured over an analysis period, distinguishing between variation in the population that is usually present in said area as obtained during the calibration stage, and variation in the additional population.

In the description below, the following notation is used:

NTot(P): a first temporal data item representative of the number of active mobile equipments (i.e. equipments that are connected) at least once in the geographical area, during a time period (P); and

NH(P): a second temporal data item representative of the number of mobile equipments that are active at least once in the geographical area, during a time period (P), and for which the habitual place of use is situated within said area.

Step E200 of geographically defining the territory is followed by a step E205 during which at least one calibration period PE and at least one analysis period PA are defined.

It is possible to select any period, having any type of duration (hour, day, week, month, year, period defined from date to date, school holiday periods, . . . ).

The calibration stage comprises a step E210 of generating a first request to obtain from the database 35 the identifiers of the mobile equipments that are active at least once during the calibration period PE.

In practice, these identifiers correspond to the identifiers recorded in the database 35 and associated with an instant or a period P lying within the calibration period PE. These identifiers are counted once only. Assume that five identifiers 5a, 5b, 5c, 5d, and 5e are obtained by this first request. They are stored in a first data structure AE as shown in FIG. 3.

During a step E220, for each of the identifiers obtained by the first request, and stored in the first structure AE, it is determined whether a habitual place of use of the mobile equipment associated with the identifier lies or does not lie within the geographical area.

In general, this determination of a habitual place of use is performed by analyzing over time the address id20 of the most recent visitor location register 20 of the switching center 14 of the most recent cell to be visited by the mobile equipment.

In a first variant, it is assumed that the population of individuals usually present in the area is constituted by the users of mobile equipments having identifiers recorded in the structure AE. This approximation is realistic whenever the calibration period PE is a period of small migratory flow to or from the geographical area, and when the percentage TxEq of residents in said area having mobile equipment is high.

In a second preferred variant described herein, each of these identifiers 5a to 5e is associated with an area flag (DSB(5i)) representative of the fact that a habitual place of use for the equipment associated with this identifier is situated within the area, whenever a utilization rate for the equipment over the calibration period PE is greater than a predetermined threshold.

These area flags DSB are stored in a second data structure having the same name and shown in FIG. 4.

In the example described herein, this data structure DSB stores for each identifier of the first structure AE and for a plurality of instants or periods t1 to t5 of the sampling period:

a value “X” if the mobile equipment associated with this identifier is active in the area at the instant ti;

and a value “O” if the mobile equipment associated with this identifier is not active in the area at instant ti.

Such information is obtained by reading the identifiers recorded in the database 35 at said instants ti.

The DSB data structure also includes, for each identifier, a DSB area flag that is equal to 1 (or 0) whenever the quantity of “X” values for the identifier is greater than or equal to (or is less than) a predetermined threshold. In the example described herein, the threshold is selected as being 80%. This threshold is defined depending on the area under observation and the type of population under observation.

Thus, it is assumed below, that only the equipments 5a, 5c, and 5d have a habitual place of use in the geographical area under study.

The step E220 of determining the habitual place of use terminates the calibration stage.

The measurement stage includes a step E230 of obtaining and storing the total number of active mobile equipments at various measurement instants in the analysis period.

In practice, this step consists in generating a second request to obtain from the database 35 first temporal data (NTot(Pi)) constituted by the total number of active equipments in the area, at various measurement instants (Pi) in the analysis period.

This first temporal data NTot(Pi) is stored in the first row of a third data structure V shown in FIG. 5.

Thus, for example, the data structure V states that 195 individuals had mobile equipment active during period P3 in the analysis period P1.

In the preferred implementation described herein the measurement method of the invention includes an optional step E240 during which a sample ECH is defined of the set {5a, 5c, 5d} of identifiers {5a, 5b, 5c, 5d, 5e} associated with an area flag DSB(5) equal to 1 in the second data structure DSB of FIG. 4.

It is assumed that the sample retained ECH is the subset {5a, 5c}.

This step is followed by a step E250 of generating a third request to obtain from the database 35 second temporal data (NH(P)) constituted by the numbers of identifiers from the sample ECH that are associated with active equipment in the area at the above-specified measurement instants P1 to P5.

When the step E240 of selecting a sample is not implemented, then the third request is generated for all of the identifiers 5a, 5c, 5d associated with a DSB area flag equal to 1.

When the sample-selection step E240 is implemented, the number NH(P) that is obtained is related to the total population of the set {5a, 5c, 5d} (is multiplied by 3/2 in this example).

This second temporal data NH(Pi) is stored in the second row of the third data structure V.

Thus, by way of example, the data structure V informs that 150 of the individuals usually active in the geographical area were in fact active at measurement instant P1.

The person skilled in the art will understand that step E230 (or E250) of generating a second (or third) request makes it possible to obtain a histogram H2 (or H3) showing:

the total number of individuals (NTot) in the geographical area; and

the total number of individuals (NH) usually to be found in the geographical area.

These histograms are shown in FIG. 6.

They make it possible during a step E260 to measure directly the variation VT within the population having mobile equipment, the total number of individuals present in the predetermined geographical area during the analysis period PA, while taking account of the variation VH in the population that is usually present in said area.

The variations VS in the additional population is obtained by taking the difference. Thus, the total number NS(P) of individuals constituting the additional population is recorded in the last row of the data structure V.

These variations VT, VH, and VS are represented by curves given the same references in FIG. 6.

Preferably, these variations are plotted relative to the total population by taking account of the percentage TxEq of individuals possessing mobile equipment.

There follows a description of an application of the measurement method in the tourism industry for measuring variation in the numbers of tourists, excursionists, and visitors in a given geographical area.

In the description below, the following NVisit(P), NTourist(P), and NExcurs(P) are used respectively to designate the numbers of visitors, of tourists, and of excursionists present in the geographical area during a predetermined time period T.

In accordance with the definition of “visitor” as given above, the person skilled in the art will understand that this population corresponds exactly to the additional population in the meaning of the invention.

In the preferred implementation described herein, these various measurements are taken as follows:

a) Evaluating the Proportion PartExcurs of Excursionists in the Geographical Area During a Day

In order to evaluate the proportion PartExcurs of excursionists, the numbers of visitors at various instants T are determined, at the beginning of the day (e.g. at 9:00 AM, NVisit(T9)), in the middle of the day (e.g. at 1:00 PM, NVIsit(T13)), or at the rush hour, and at the end of the day (e.g. at 7:00 PM, NVisit(T19)).

Then, the proportion of excursionists in the geographical area at the predetermined period P or over said day is obtained as follows.
ParExcurs=[NVisit(T13,D)−average(NVisit(T9,D); NVisit(T19,D))]/NVisit(T13,D)
b) Evaluating the Proportion of Tourists PartTourist

The proportion of tourists PartTourist is obtained as follows:
PartTourist=100%−PartExcurs
c) Evaluating the Number of Tourists Using a First Method

In a first implementation, the number of tourists NTourist(D) is evaluated using the following formula:
NTourist(D)=[average(NVisit(T19,D); NVisit(T9,D+1)]+(1/TxEq)
in which:

NVisit(T19,D) corresponds to the number of visitors present in the geographical area at the end of the day D, e.g. at 7:00 PM;

NVisit(T9,D+1) corresponds to the number of visitors present in the geographical area at the beginning of the following day, e.g. at 9:00 AM; and

TxEq corresponds to the percentage of the population having mobile equipment.

In the implementation described above, the above-specified population percentage is that which applies to the country in which the method is used.

It is a mean rate of equipment possession, weighted as a function of the visitors most present on the site. It is tracked and updated.

d) Evaluating the Number of Tourists Using a Second Method

In another implementation, the number of tourists NTourist(D) is evaluated using the following formula:
NTourist(D)=NVisit(D)×PartTourist×(1/TxEq)
e) Evaluating the Number of Excursionists Entering the Geograthical Area Defined in Step E200 During the Day D

In the preferred implementation described herein, this number is obtained as follows:
NExcurs(D)=NVisit(D)×PartExcurs×(1/TxEq)

The number of bed nights NNuitée during a predetermined number of days is evaluated by accumulating the number of tourists NTourist(D), NTourist(D+1), NTourist(D+2) evaluated for each of the days in question.

The numbers of residents, visitors, tourists, and/or excursionists can be further subdivided using at least one of the following criteria:

the main place of residence of an individual;

a socio-professional category; and

an age range.

In known manner, this operation consists in multiplying the number of individuals of the selected kind by the relative weight of the category that corresponds to the selected criterion.

In a preferred implementation, places of residence are the postal or zip codes obtained from the mobile operator in another database that forms part of the operation subsystem (OSS) of the network.

In a preferred embodiment, data coming from a plurality of operators can be combined in the database 35 and processed by the measurement method of the invention.

When there are operators present in the geographical area defined during step E200 from which it is not possible to obtain data concerning the numbers of mobile equipments present, then a correction is applied to the data obtained from other operators, taking account of the respective market shares as provided by the regulatory bodies and the license allocations in each of the countries where the method of the invention is implemented.

The method of the invention may advantageously be used for estimating the populations present in a hazardous geographical area and for triggering specific measures for protecting residents or visitor populations in a hazardous geographical area.

Such hazardous geographical areas may be constituted, for example, by areas liable to flooding, areas subject to industrial or fire risks, e.g. areas having a SEVESO classification, and nuclear power stations.

The invention thus makes it possible to analyze occupancy over time of said areas in order to evaluate the kinds of population that need to be evacuated in the event of danger and in order to model the prevention measures to be taken.

It is also possible to use the measurement method of the invention to observe an area in almost in real time and to alert the authorities in charge of safety very quickly, distinguishing being residents and visitors to the area.

The invention can also be used for analyzing road traffic and to estimate traffic by monitoring the cells 11 to which mobile equipment 5 make connections.

Naturally, such information is of direct use in the field of transportation.

The invention can also be particularly advantageous in providing mobile telecommunications operators with information concerning potential network occupation in a given geographical area, by distinguishing between the resident population and the visiting population.

What is claimed is:

1. A method of measuring the variation of the total number of individuals present in a determined geographical area over an analysis period, including distinguishing between variation in the population that is usually present in said area and the variation in the population additional thereto, each individual being in a position to use mobile equipment that is capable of being located, the method comprising:
at least one calibration stage comprising the following steps:
generating a first request to obtain from a database the identifiers of mobile equipments that are active at least once in said geographical area during a calibration period; and
determining for each identifier, an area flag representative of the fact that a habitual place of use of the equipment associated with the identifier is or is not situated in said predetermined area; and
at least one measurement stage comprising the following steps:
generating a second request for obtaining, from said database, first temporal data constituted by the total number of active equipments in the area, at various measurement instants in the analysis period;
generating a third request to obtain, from said database, for the identifiers associated with an area flag representative of having a habitual place of use situated in said area, second temporal data constituted by the number of said identifiers that are associated with an equipment that is active in said area at said measurement instants; and
measuring the variation in the total number of individuals present in said predetermined geographical area, during said analysis period, while distinguishing between variation in the population usually present in said area and variation in the additional population, on the basis of said first and second temporal data.

2. A measurement method according to claim 1, wherein said third request is generated solely for a sample of the set of identifiers associated with an area flag representative of having a habitual place of use situated in said area.

3. A measurement method according to claim 1, wherein, during said determining step, an identifier is associated with an area flag representative of the fact that a habitual place of use associated with said identifier is situated in said area, when a utilization rate of said equipment over said calibration period is greater than a predetermined threshold.

4. A measurement method according to claim 1, wherein, during said measuring step, account is taken of the percentage of individuals that dispose of mobile equipments.

5. The use of a measurement method according to claim 1 for dimensioning a telecommunications network installed in said predetermined area.

6. The use of a measurement method according to claim 1, for analyzing or anticipating a flow of population movement entering or leaving the area.

7. The use of a method of evaluation according to claim 1, for triggering specific measures for protecting resident or visitor populations in a hazardous geographical area.

8. The use of the measurement method according to claim 1, for measuring, from said first and second temporal data, the variation in the numbers of tourists and excursionists in the area, during said analysis period.
